(19) United States
(12) Patent Application Publication
(10) Pub. No.: US 2013/0191306 A1
(43) Pub. Date: Jul. 25, 2013

(54) Providing Operational Business Intelligence

(71) Applicants: William K. Wilkinson, Sam Mateo, CA (US); Alkiviadis Simitsis, Santa Clara, CA (US); Umeshwar Dayal, Saratoga, CA (US); Maria G. Castellanos, Sunnyvale, CA (US)

(72) Inventors: William K. Wilkinson, Sam Mateo, CA (US); Alkiviadis Simitsis, Santa Clara, CA (US); Umeshwar Dayal, Saratoga, CA (US); Maria G. Castellanos, Sunnyvale, CA (US)

(21) Appl. No.: 13/825,024

(22) PCT Filed: Oct. 14, 2010
(86) PCT No.: PCT/US2010/052658

§ 371 Date: Mar. 19, 2013

(51) Int. Cl. G06Q 10/06

(52) U.S. Cl. CPC G06Q 10/067
USPC 705/348

(57) ABSTRACT

Embodiments described herein can be used to provide business intelligence. For example, a tangible, computer-readable medium may include code configured to direct a processor to create a conceptual model of an business process. The code may be configured to direct the processor to parse the conceptual model to create a logical model of the business process, and to parse the logical model to create a physical model of the business process.

### BACKGROUND

Enterprises use business intelligence (BI) technologies for strategic and tactical decision making. In many cases the decision-making cycle may span a time period of several weeks, such as in campaign management, or months, such as in improving customer satisfaction. Traditional BI architectures are designed to support reactive decision-making based on summarized and historical data. To support this function, extract-transform-load (ETL) jobs may be used to extract operational source data from various systems in an enterprise and load it into a data warehouse for analysis and viewing. The ETL jobs often operate on a weekly or even a monthly time interval.

### BRIEF DESCRIPTION OF THE DRAWINGS

Certain exemplary embodiments are described in the following detailed description and in reference to the drawings, in which:

FIG. 1 is a block diagram of a corporate system, in accordance with an embodiment;

FIG. 2 is a block diagram of a method for creating an extract-transform-load (ETL) process, in accordance with an embodiment;

FIG. 3 is an illustration of business process modeling notation (BPMN) symbols, in accordance with an embodiment;

FIGS. 4A, 4B, and 4C are block diagrams of a daily revenue ETL conceptual model in BPMN, in accordance with an embodiment;

FIGS. 5A and 5B are block diagrams of a campaign ETL conceptual model, in accordance with an embodiment;

FIG. 6 is a block diagram of a daily revenue ETL physical model, in accordance with an embodiment;

FIG. 7 is a block diagram of anextract-transform-load (ETL) system, in accordance with an embodiment; and

FIG. 8 is block diagram of a non-transitory computer readable medium containing code, in accordance with an embodiment.

### DETAILED DESCRIPTION

Although, traditional extract-transform-load (ETL) processes provide useful business intelligence (BI), competitive pressures are forcing companies to react faster to rapidly changing business conditions and customer requirements. As a result, there is an increasing need to use BI to help drive and optimize business operations on a daily basis and even for intraday decision making. This type of BI may be termed operational business intelligence. The short decision-making cycle can require a tight connection between the BI system and the operational business processes underlying business operations.

As used herein, a business process, or ETL process, is a higher level process that may be used to provide business intelligence to a decision maker. In contrast, an operational business process is a lower level process from which the data may be obtained, such as an ordering process, a checkout process, a delivery process, and the like,

Embodiments described herein provide systems and methods for providing operational business intelligence (BI). The systems and methods generate models that link the processes used to generate business views with the operational processes of an enterprise. The techniques are based on a layered methodology that starts with modeling the business processes of the enterprise, the BI information requirements, and the associated service level objectives. A conceptual model and a logical model are linked through intermediate layers to provide a link between business requirements and physical implementations. The techniques use the concept of quality objectives, termed QoX objectives, to drive the optimization of the design. In an embodiment, business process models are used for the conceptual models of extract-transform-load (ETL) designs. For example, the business requirements may be captured using the best practices of an ETL designer, perhaps using some combination of text files, spreadsheets, diagrams, and the like. These requirements can then converted by the designer to a conceptual model that is expressed as a business process.

This approach can provide a unified formalism for modeling both production, e.g., operational processes such as Order-to-Revenue, as well as the end-to-end enterprise data in the warehouse, which offers a high level view of the process populating the warehouse. In an embodiment, the approach can provide a business view of an intermediate enterprise state, such as placed orders yet to be fulfilled. In addition, the approach enables an ETL design that hides the low-level IT details and therefore facilitates the specification of Service Level Agreements (SLAB) and metrics by business analysts.

Business process models are used at an ETL conceptual level. In an embodiment, for each business view, such as a fact table, a dimension table, a roll-up view, and the like, there is a corresponding ETL conceptual process that describes the steps needed to construct that view. The ETL conceptual process can be expressed in various notations that provide convenient graphical display, such as business process modeling notation (BPMN), among others. The various operational business processes may also be expressed in BPMN and can be linked to the ETL conceptual processes, or business processes, by inserting probes into the operational processes that send events or messages that are relevant to the target of the ETL process. For example, a message may be sent from a warehouse system when an order is scheduled for delivery. The message may contain such information for the order as the item, the customer, the date, the sales price, the tax, and the like. Other local data sources may be probes in addition to, or instead of, the warehouse system.

Although BPMN describes process flow, ETL is fundamentally concerned with data flow. Consequently, to capture data flow the ETL conceptual models have data objects, such as documents, associated with each task or step in the process flow. The document associations describe input schemata, output schemata, and parameter schemata for the task. Embodiments are not limited to this approach as any other mechanism might also be used to capture data flow. Similarly, business requirements and objectives for the ETL transformation process, e.g., having to do with latency, reliability, scalability, provenance, and the like, may also be captured in document associations. These may also be associated to some particular task in the conceptual process or associated with the process as a whole, e.g., through an association with a start task.

The compilation and optimization of an ETL conceptual process to an implementation proceeds through several stages. The first stage is the translation of the conceptual process to an ETL logical model. The subsequent stages include translation from the ETL logical model to a physical model and implementation of the physical model. The ETL logical model can be represented as a parameterized, directed acyclic graph (DAG) where the vertices represent either activities, such as operations on data, or data stores, such as tables in a database or files in a file system. The edges of the DAG can represent data flow. The parameters of the graph may be used to capture design information such as business requirements and objectives resources needed for execution, and the like. It will be noted that both the ETL conceptual model and the ETL logical model can be embodied in XML notation.

The translation from ETL conceptual model to an ETL logical model can be based on two techniques, a search for patterns, and a simple expression language. There are several patterns that may be identified in a BPMN flow. For example, a BPMN exclusive branch task in which one branch terminates immediately is a common pattern that indicates a logical ETL filter operation. As another example, a BPMN message receive task followed by a splitter task that is further followed by an appendFile task reflects a logical ETL extract operation from a data source. In this operation, the splitter identifies data sources to be joined, for example, an order table that is to be joined with a line item table. Business requirements may determine the corresponding logical ETL operation. Normally, the extraction would be done to a staging table but too maintain high freshness, the extraction may be done with a real-time operator, such as a mesh-join.

The second translation technique, e.g. from ETL logical model to physical model, uses a simple declarative language. Each conceptual process task has a name and can be annotated with documents describing the input, output, parameter schemata, business requirements and objectives, and a set of expressions. This language can be expressed in XML, and it is straightforward for a parser to transform from the conceptual model in XML to the logical model in XML based on the task type or name and the annotations.

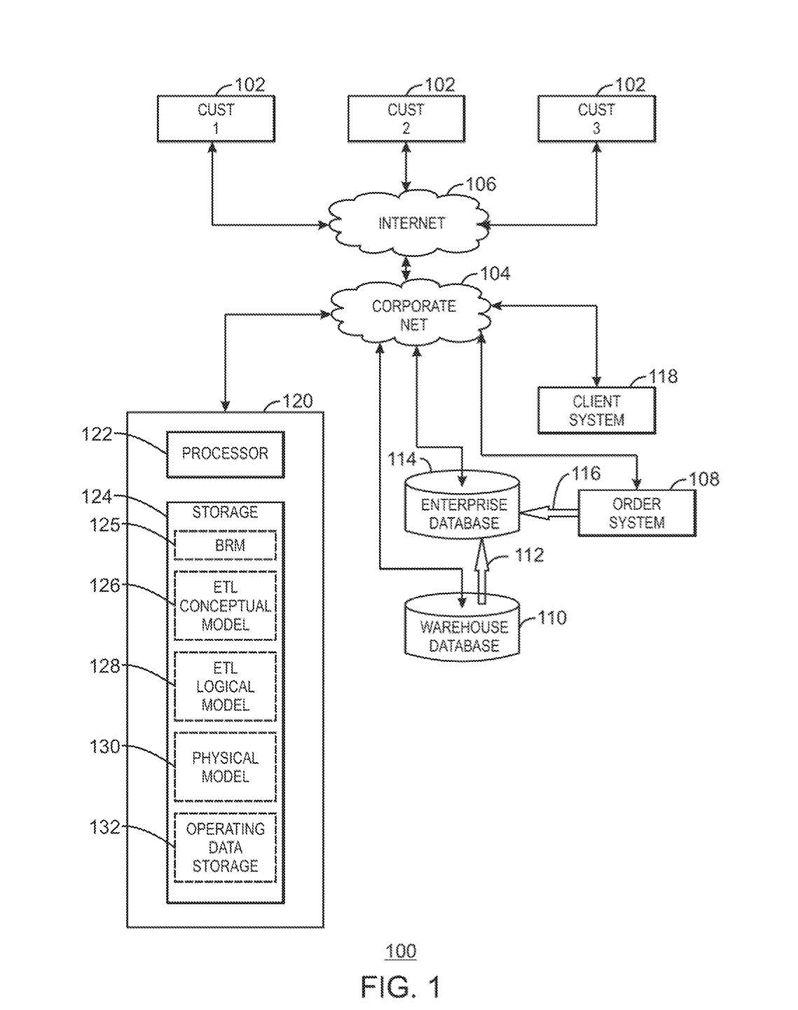

FIG. 1 is a block diagram of a corporate computing system 100, in accordance with an embodiment. Using the corporate computing system 100, customers 102 may access a corporate network 104, either directly through a local area network (LAN), a wide-area network (WAN), or indirectly through the Internet 106. Through the corporate network 104, the customers 102 may perform an electronic business transaction, such as examining products and placing an order in an order system 108. The order system 108 may validate a payment technique and then place a request for shipping in a warehouse database 110 through the corporate network 104.

At some interval, for example, weekly, an extract-transform-load (ETL) transaction 112 may be performed to obtain records from the warehouse database 110 and store them in an enterprise database 114. A similar ETL transaction 116 may be used to obtain records from the order system 108. A client system 118 may then be used by an information consumer, such as a manager, to examine the records in the enterprise database 114 to make business decisions. However, the ETL transactions 112 and 116 may not be run on a frequent timeframe, for example, only running on a daily, weekly, or even monthly basis. Thus, while the information may be useful for longer term decisions, it may not be as useful for shorter term decisions. For example, a very successful marketing or sales campaign may not be stopped in time to prevent a sold out or back order situation, leading to higher costs. Further, the information may not include information concerning intermediate steps in the business processes and, thus, may not allow the capture of opportunities. For example, a marketing campaign may be directed based on the specific items a customer orders or on the payment method used by the customer. The client system 118 could be used to directly access either the order system 108 or the warehouse database 110 through the corporate network 104, but the information would likely not be in a consistent format and may require substantial expertise for interpretation, potentially limiting its usefulness.

In an exemplary embodiment, an ETL system 120 may be used to extract short term and/or intermediate data from the various data stores in the corporation, such as the order system 108 and the warehouse database 110, among others. The ETL system 120 may have a processor 122, which may be a single or multi-core processor in a dedicated computer system, or may be a virtual unit allocated from a cluster of computing cores in a cloud computing system. The ETL system 120 does not have to be a dedicated system, as a cloud computing arrangement may be used to operate all of the data stores and functional units described herein.

A storage system 124 may be used to hold operating code for the ETL system 120 as well as the various functional data structures used to implement embodiments. The storage system 124 may include any combinations of non-transitory, computer readable media, such as read only memory (ROM), random access memory (RAM), hard drives, optical drives, RAM drive, and the like. The functional data structures may include a business requirements model 125. An ETL conceptual model 126 may be present, for example, written in business process modeling notation (BPMN), as discussed below. The storage system 124 may also hold an ETL logical model 128, such as a parameterized, directed acyclic graph (DAG) representing the ETL flow. Both the ETL conceptual model 126 and the ETL logical model 128 may be expressed as similar data structures, for example, in XML. The storage system 124 may also hold a physical model 130, which is used for the actual implementation of the ETL process. The physical model 130 is translated from the ETL logical model 128, and may hold the links to the data sources, such as the specific documents in the order system 108 or warehouse database 110, among others. An operational data storage 132 area may be used to hold intermediate results from the ETL process. The ETL process may also place the results directly into the enterprise database 114.

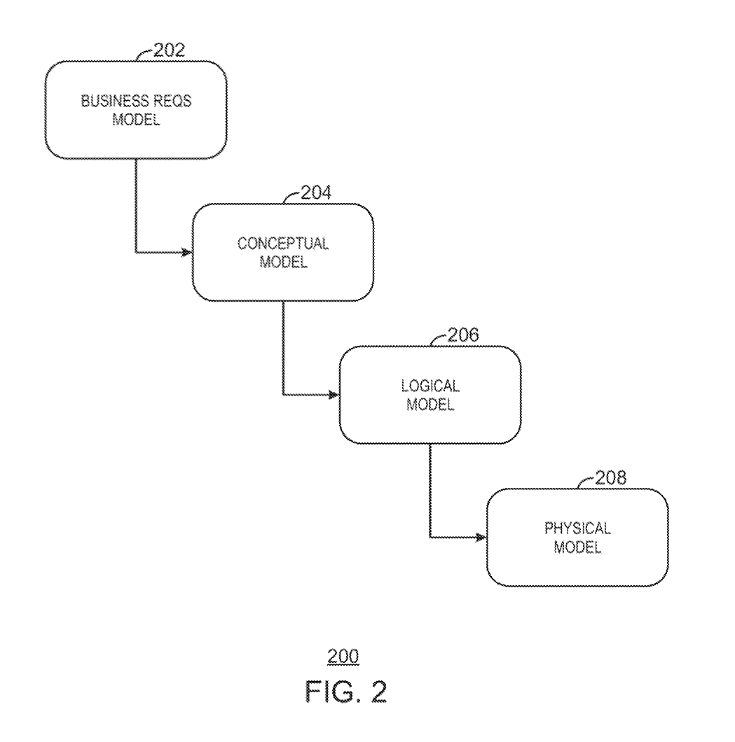

FIG. 2 is a block diagram of a method 200 for creating an extract transform load (ETL) process, in accordance with an embodiment. As shown in FIG. 2, the design methodology 200 may start with the creation of a business requirements model (BRM) 202 that specifies business views in the context of the operational business process and whose execution triggers the generation of those views. The business requirements also capture the business rules for constructing the business views. For example, the business rules may not count internal orders in revenue, may ignore sales tax on out-of-state orders, and the like. Business views are information entities that allow the user to view how the business is going in a timely manner. They are derived from source data manipulated by operational business processes and correspond to facts in a data warehouse. It can be noted that the BRMs described herein are merely presented to simplify the explanation of the BTL process creation. However, embodiments are not limited to these BRMs Of, indeed, any particular type of business requirement model.

A BRM 202 may reference a number of business processes and show the flow between separate portions. For example, a BRM may reference various operational business process such as a purchasing operation that may have a checkout process, a delivery process, a process for accumulating order lines, and a process for computing a daily revenue flow, among many others. These processes may be represented by a simple flow between actions.

For example, a checkout process may start by checking inventory to determine if an item is in stock. If not, the process may notify the customer and cancel the order. If the item is in stock, the process may calculate the payment, create the order, confirm the order, and initiate the delivery process. The delivery process may have the product packaged, schedule pickup, schedule shipment, and await confirmation of delivery. The process for accumulating order lines, which may be termed accumulateOrderLines, is triggered by the scheduling of shipping. In the accumulateOrderLines, the order details are obtained and the lineItems for each product or order are separated. Tax may be calculated and the lineItems may be accumulated to produce a set of accumulated orderliness. For computing the daily revenue, a timed event, such as the end of the week, may trigger a process termed computeDailyRevenue. This process takes the accumulated orderliness and partitions them by date and product. The amounts of each sold are aggregated, and the daily revenue is calculated by date and product. Various objects may be created to implement the functions of the BRM. For example, the accumulatedOrderLines object may be implemented as shown below.

```
INTERMEDIATE OBJECT AccumulatedOrderLines
    DataAttributes
        amount: float
        day: Date
        product: String
    DerivationRule:
        ON update (Order, ShippingDate) //shipping event
        IF (Order, ShippingAddress, not Null)
        INVOKE AccumulateOrderLines
END INTERMEDIATE OBJECT
```

Similarly, various processes may be created to implement the functions of a BRM. For example, a business view process termed dailyRevenue may be implemented as shown below.

```
BUSINESS VIEW DailyRevenue
    DataAttributes
        totalAmount: float
        day: Date
        product: String
    QualityAttributes:
        Freshness: weekly
    DerivationRule:
        ON end of week //temporal event
        IF AccumulatedOrderLines.amount is not null
        INVOKE ComputeDailyRevenue
END BUSINESS VIEW
```

The notation used to express the objects and processes of a BRM, or any embodiments, are not limited to the example object or processes shown above. Any number of other objects and processes may be used to model business processes in various embodiments. For example, a process may be modeled by operational business processes including, for example, the Order-to-Revenue, Shopping, Checkout, and Delivery processes, among others. It may be assumed that a business user is interested in analyzing daily revenue on a weekly basis. For this purpose, the business view, dailyRevenue, is defined as shown previously. While operational business processes are process-centered, business views are data-centered. However, a uniform approach may represent both, for example, as graphs at the business requirements level and as BPMN processes at the conceptual level.

The business requirements in the BRM 200 may often be captured by personnel, for example, through interviews with the business users. Thus, the BRM 202 is intended primarily for communication with the data consumers. At block 204, a conceptual model is defined by the ETL designer, for example, by translating the BRM 202 into business process modeling notation (BPMN). Although the conceptual model 204 can contain more technical details, it may still be considered a high level model. After the conceptual model 204 is created, it may be used for producing a logical model 206 that is still more detailed and can be optimized. Finally, a physical model 208 is created that can be executed by an ETL engine. In an embodiment, only the physical model 208 may be tied to a specific ETL engine.

The requirements for the process can be expressed at the business layer, for example, in the BRM 202, as service level agreements (SLAs) defined over a set of quality objectives. The SLAs can be represented as a set of metrics called QoX metrics. A non-exhaustive list of QoX metrics includes, for example, performance, recoverability, reliability, freshness, maintainability, scalability, availability, flexibility, robustness, affordability, consistency, traceability, and auditability. Some metrics are quantitative, such as reliability, freshness, and cost, among others, while other metrics may be difficult to quantify, such as maintainability and flexibility. The QoX metrics may be used to measure specific quality targets, called QoX objectives.

At each design level, the QoX metrics are introduced or refined from higher levels, presenting opportunities for optimization at each successive level of specification. In an embodiment, optimizations at all design levels can be driven by the QoX objectives. The QoX objectives, in effect, prune the search space of all possible designs, much like cost-estimates are used to place bounds on a search space in cost-based query optimization.

To achieve the optimization, at each design level, the constructs constituting the ETL flows are annotated with specifications influenced by key quality objectives. The annotations are also taken into consideration for transitioning from one level to the next. There may be several alternative translations from operators in the conceptual model 204 to operators in the logical model 206 and these alternatives are determined by the QoX objectives and their tradeoffs. For example, operators for a recovery point insertion may be added after certain operators when recoverability is a QoX objective. The operators may include, for example, sort, aggregate or blocking operators. Generally, any operator, or series of operators, that are expensive or impossible to repeat would be a candidate for a recovery point. Similarly, the translation from the logical model 206 to the physical model 208 enables additional types of optimizations to be driven by QoX objectives. The basic notation used for generating the conceptual model 204 is business process modeling notation (BPMN). Further details of preparing the conceptual models 204, logical models 206, and physical models 208, in accordance with embodiments of the present techniques, are discussed below,

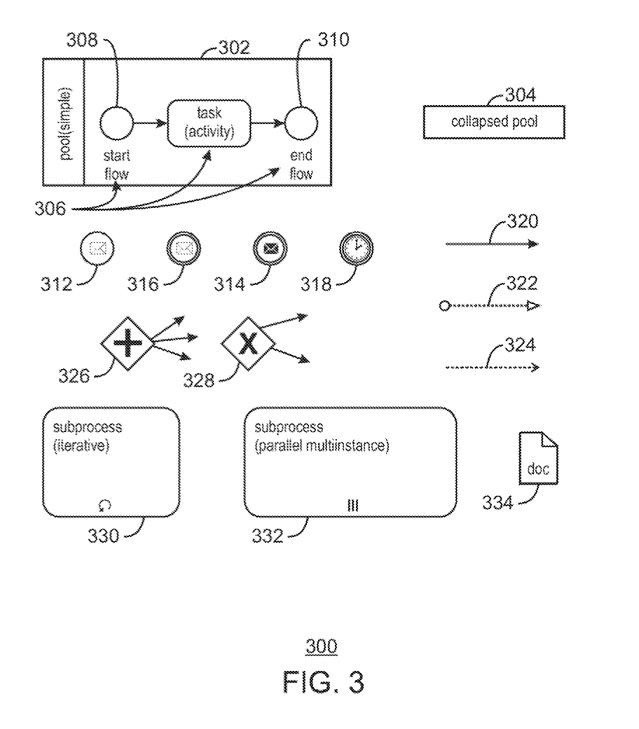

FIG. 3 is an illustration 300 of some of the symbols that may be used for business process modeling notation (BPMN), in accordance with an embodiment. It will be clear that this list is not a complete listing of all symbols that may be used in BPMN notation, but merely an example of a few important symbols that may be used in various embodiments. BPMN is a standard for documenting business processes in graphical terms. However, embodiments are not limited to BPMN, but may use any number of modeling or visualization techniques, as discussed herein. In BPMN, a process comprises a number of pools 302 where each pool 302 defines a separate process flow. A pool 302 may be visible or it may be collapsed 304. When collapsed 304, the pool is represented by a single icon where its internal details are not visible, which may make other portions of a diagram more visible. A pool 302 can comprise a sequence of 306 having a single start event 308 and one or more end tasks 310.

Messages may be exchanged between pools to model communication among business processes. The start event 308 may, for example, be a message 312 from another process. Tasks 306 may also send messages 314 to other tasks or processes may hold and wait for messages 316. Processes may also hold and wait for a timer 318 to complete.

Process flow between tasks 306 may be indicated by arrows of different types. For example, a sequence flow may be indicated by a solid line 320, while a message flow may be indicated by a dashed line 322 having a circle at the start. An association between a task and a document (or information source) may be indicated by a dashed line 324 having no circle at the start.

A branch step may be parallel 326, indicating that the concurrent activities in each branch proceed in parallel. Alternatively, a branch step may be exclusive 328, indicating that only one branch proceeds, for example, after an if-then-else or other conditional test.

A task may itself be a sub-process which can be useful for encapsulation within a pool 302. For example, an iterative sub-process 330 may repeat until some condition is met. Further, a parallel sub-process 332 may create an arbitrary number of parallel flows. BPMN also supports artifacts that may be associated with tasks. In an embodiment, data objects, such as documents 334, are associated with tasks to model data flow.

Business process models, such as those encoded in BPMN, describe control flow. However, ETL processes are fundamentally concerned with data flow. For example, while BPMN can describe a sequence of steps in a flow, it does not require that the data objects used in the steps be described. Further, ETL processes generally operate over datasets that represent an entire day or perhaps week of business activity. In contrast, an operational business process may represent a single business activity, such as an order, payment validation shipping request, and the like. Thus, an ETL process can aggregate a number of business flows. In an embodiment, these two different perspectives can be reconciled as discussed below. Further, QoX metrics may be used within a model encoded in BPMN.

To address the data flow issue, data objects, such as documents, may be associated with steps in a business process. The document associations may be used to represent data flow in BPMN. Each task has an associated input document and an output document. The input document describes the input data objects and their schemas as well as the parameters for the task. The output document identifies the result object and its schema. To track the QoX metrics for the ETL process, a document, labeled QoX in the following diagrams, can be designated to contain the QoX objectives.

To address the conversion from single process instances to data-sets, a design pattern can be used that models each business view as four related flows: scheduler, extract, fact, and load. In this context, fact is used generically to refer to any data warehouse object, for example, dimensions, roll-ups, and fact tables, among others. The scheduler coordinates the other three flows for example, starting and stopping them, encoding QoX objectives as parameters, and so on.

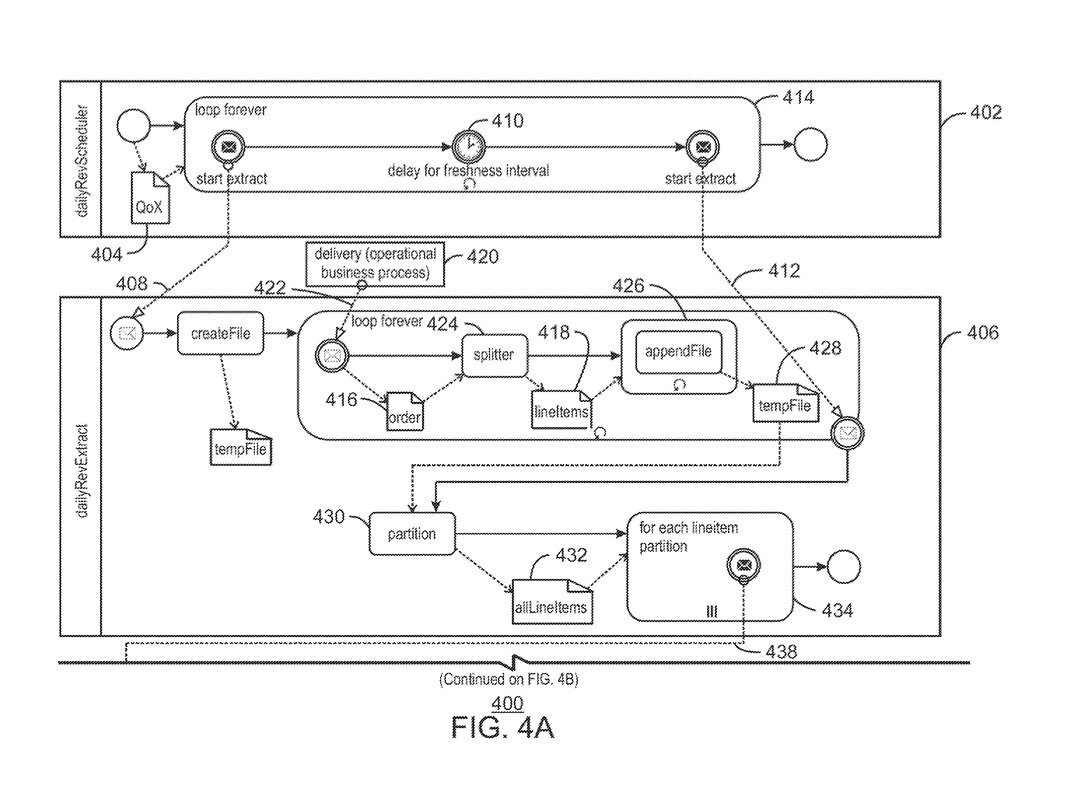

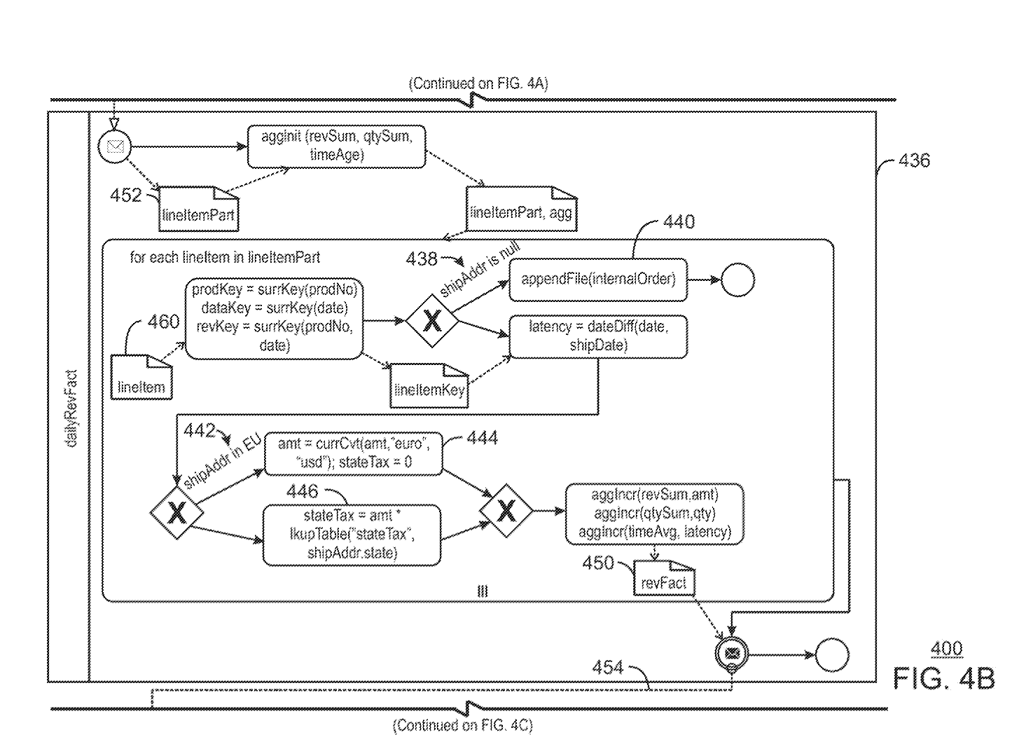

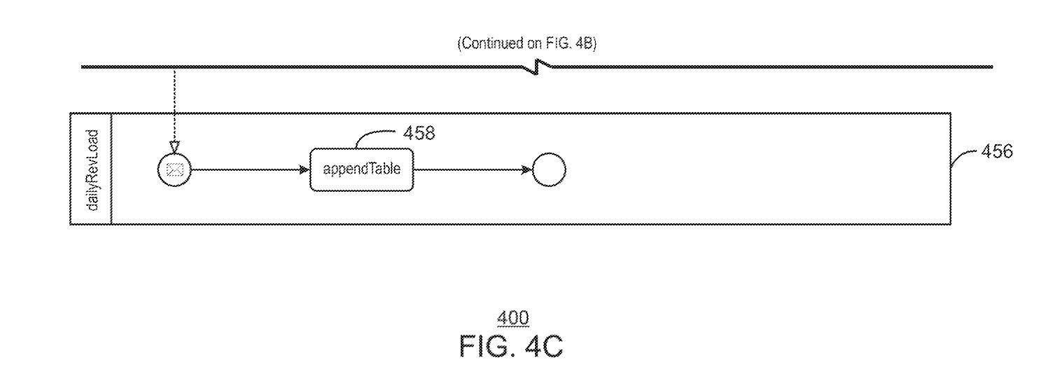

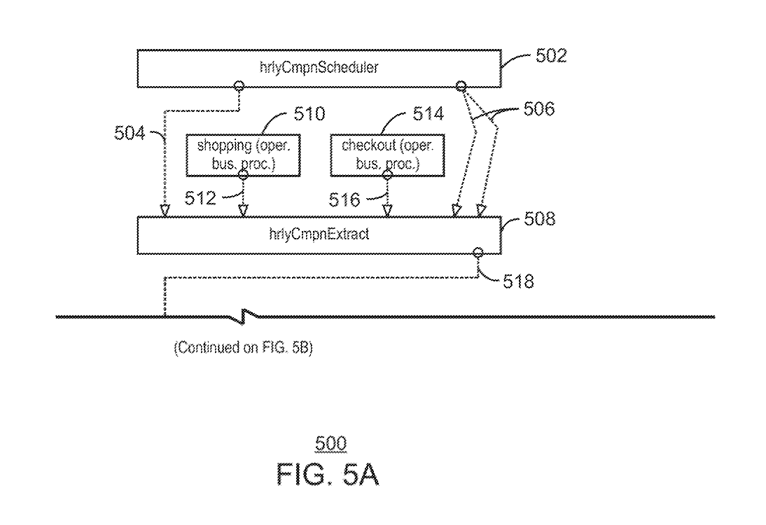

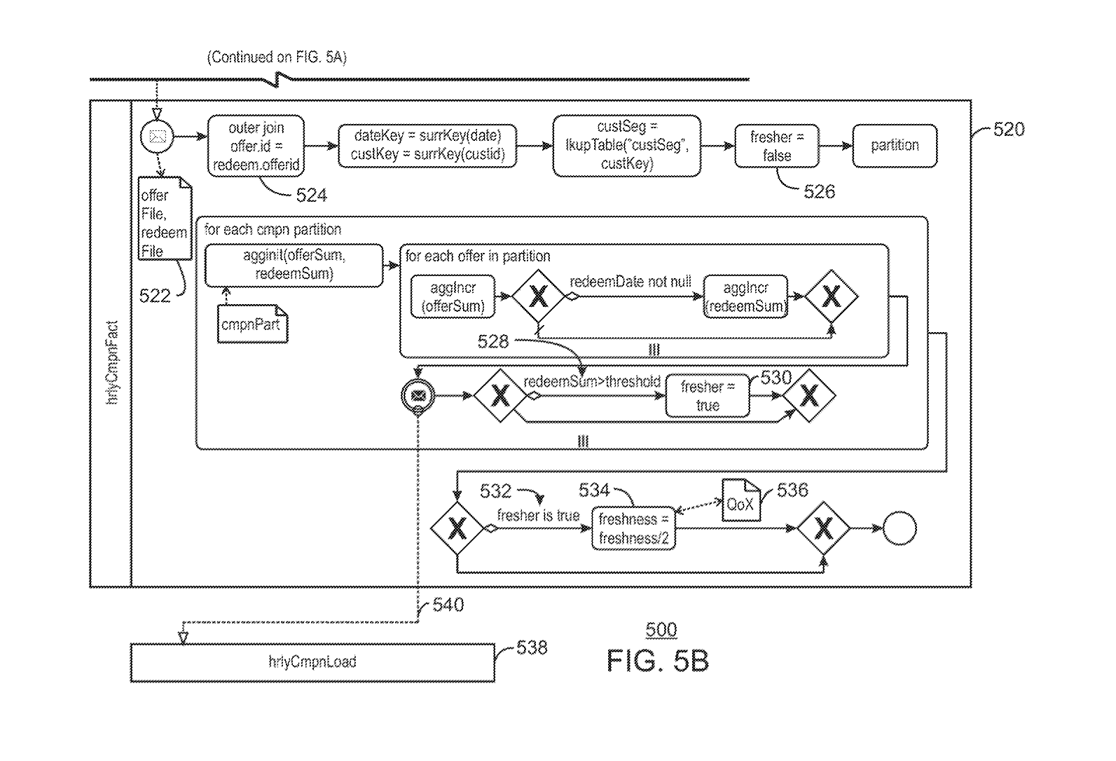

The remaining flows correspond roughly to the extract, transform, and load steps of an ETL process. The extract flow can interface with operational business processes to obtain data. For example, probes inserted into the operational business processes may send messages to notify the extract flow of relevant business events, such as events that correspond to activities in a business requirements model (BRM) 202 (FIG. 2). The extract process aggregates the business events required by the fact flow. The fact flow performs the bulk of the work. It use the raw business event data aggregated by the extract process and transforms it to a data warehouse view. The resulting view instance, for example, a fact object, may then added to the data warehouse, such as the enterprise database 114 (FIG. 1), by the load flow or may be stored in a local operation data, storage 132. In an embodiment, the QoX objectives can be captured at all three levels of granularity, process level, flow level, and task (or operator) level. The distinguished QoX document addresses the flow level. Document associations address the task level. The process level is addressed by a process or global level QoX document that is inherited by all flows. The use of BPMN to generate conceptual models that can be used for ETL processes is discussed further with respect to FIGS. 4 and 5.

FIGS. 4A, 4B, and 4C are block diagrams of a conceptual model for a daily revenue process 400 in BPMN, in accordance with an embodiment. The daily revenue process 400 illustrates an Order-to-Revenue process, for example, as discussed with respect to block 202 of FIG. 2. It will be apparent that this is merely an example of one business process in which the techniques discussed herein may be used. The daily revenue process 400 may comprise two flows, or operational business processes, from which information can be extracted, checkout and delivery. It may be assumed for purposes of explanation that the warehouse database 110 (FIG. 1) contains a DailyRevenue fact table that records the total quantity, revenue and average time to ship for each product sold per day, for example, it may have the schema <datekey, prodKey, quantityTotal, revenueTotal, TimeAvg>. As mentioned herein, a BRM model may be used to communicate business requirements to an ETL designer who uses it as input to produce a conceptual model that has the necessary level of detail to be processed to generate a logical model.

In the BPMN diagram for the DailyRevenue process 400, it ay be assumed that the QoX objectives specify high reliability and a freshness parameter, such as one week. The scheduler flow 402, shown as a BPMN pool 302 (FIG. 3), includes the QoX document 404 at the start of the flow 402. The scheduler 402 then starts an extract flow 406 by sending a message 408. The scheduler flow 402 then delays 410 for a freshness interval, taken from the OcX document 404. After the freshness interval, the scheduler flow 402 then stops the current extract flow by sending another message 412 and loops back to start a new extract for the next freshness interval, as indicated by the loop sub-process 414. For example, the event in the derivation rule of the DailyRevenue business view in the BRM may be used to determine the freshness interval. To simplify the diagram not all document associations within each of the flows are shown.

The extract flow 406 aggregates order information that may be used to compute the DailyRevenue fact, for example, orders 416, lineItems 418, and allLineItems 420. In an embodiment, the extract flow 406 has a link to an operational business process that confirms an order, for example, delivery 420. The extract flow 406 receives a message 422 from delivery 420 for each booked order once it is shipped. The message 422 may be derived from a corresponding action for an accumulateOrderLines process in the BRM model, discussed above. Since a BRM may be a representational or design model, it does not require that an implementation use a message interface to an operational business process. Accordingly, the translation from the BRM to the conceptual model, and then to the logical and physical ETL models will use QoX objectives to determine if the extract flow should use a message probe, in near real-time, or a periodic extract from a source table.

During the specified freshness interval, a splitter task 424 takes the order 416 and extracts lineitems 418, which are appended 426 to a temporary file 428 that may correspond to an AccumulatedOrderLines intermediate object in the BRM model. At the end of the freshness interval as signaled by the message 412 from the scheduler 402, a partition task 430 groups the spooled lineitems 418 in the temporary file 428 by date and product number to create an allLineItems document 432. Finally, for each line item, or product, in the allLineItems 432, a parallel task 434 creates an instance of a fact flow 436 by sending a message 438 containing the lineItems 418 for a specific date and product as shown in FIG. 4B.

For purposes of this example, it may be assumed that the fact flow 436, for example, corresponding to the data flow for computing the dailyRevenue in the BRM, computes three aggregate values for each partition of date and product: total quantity of items sold, total revenue and average time to fulfill the order. In addition, three business rules may be assumed. First, internal orders, indicated by a null shipping address 438, should not be counted. Instead, as indicated at block 440, the items are appended to an internalOrders file. Second, for orders with a European shipping address 442 the revenue currency must be converted from Euros, as indicated at block 444. Third, non-EU orders are assumed to originate in the United States so sales tax must be computed using a lookup table, as indicated at block 446. In other embodiments, different rules will be used to determine currency conversions, for example, if sales are made in other countries or regions.

Generally, more detail can be used in an ETL conceptual model, such as the DailyRevenue process 400, than for a BRM. In an embodiment, a set of predefined functions may he provided to and used by all flows, including, for example, surrKey, dateDiff, IkupTable (table lookup), aggInit (aggregate aggIncr (aggregate increment), appendFile, and appendTable, among others. The surrogate key transformation, surrKey, converts from production keys to data warehouse keys. Other functions may be specific to a specific implementation, such as currCvt, used for currency conversion. In this example, the result of the fact flow 436 is to provide a document, revFact 450 for each lineItem in the lineItemPart 452. The fact flow 436 can then send a message 454 with the revFact 450 to the load flow 456, shown in FIG. 4C, to add the new fact to a data warehouse, such as the enterprise database 114 (FIG. 1) or the operational data storage 132. This may be performed, for example, using an appendTable task 458.

FIGS. 5A and 5B are block diagrams of an ETL conceptual model for a marketing campaign 500, in accordance with an embodiment. A web-retailer may periodically run marketing campaigns, for example, to sell end-of-life-cycle products to certain customer segments, or to test the appeal of new products, and the like. It may be assumed for purposes of this example that for a given campaign 500, the retailer wants to track the number of offers made and number of offers accepted (redemptions) for each customer segment for each hour of each day. For this process, the quality objectives in the QoX document can start as freshness per week, but may have a low reliability parameter. In an embodiment, reliability may be measured as an amount of data that may be lost during the Ell process while still providing meaningful results. In this case, the reliability may not need to be high because the enterprise can tolerate lost data for this process and, thus, the individual hourly data points may not be as important as the trends. In an embodiment, reliability can be defined, for example, by a process expert, that may state that a certain number of failures is acceptable.

Further, in this embodiment, if a campaign 500 shows more activity than expected, then the freshness can be increased, for example, to daily or even hourly loads, to give a marketing team faster feedback on the campaign 500. Thus, in an embodiment. QoX objectives may be modified in real-time based on the state of the enterprise and changes in QoX objectives can trigger an automatic generation of new ETL logical and physical models for the process. In contrast, in conventional approaches to ETL, the models are relatively static and not driven by objectives, making adaptation to changing conditions more difficult.

The scheduler 502, which is not shown in detail, functions in a similar fashion to the scheduler 402 discussed with respect to the DailyRevenue process 400 of FIG. 4. For example, the scheduler 502 can send a first message 504 to start the extraction process and send one or more second messages 506 to control or stop the extraction process. The timing of these messages can be set by a freshness parameter contained in a QoX document, as discussed below. The extract flow 508, which is also not shown in detail, can interact with two operational business processes. A shopping process 510 may send a message 512 whenever a customer is presented with an offer while browsing the web site. A checkout process 514 may send a message 516 whenever an offer is redeemed for a sale.

The extract flow 508 creates two temporary files during the freshness interval, one for offers and another for redemptions. The extract flow 508 also sends a message 518 to start the fact flow 520, shown in FIG. 5B. The message 518 may contain various temporary files 522, generated by the messages 512 and 516 concerning offers and redemptions. The fact flow 520 then uses the temporary files 522 for its analysis.

The fact flow 520 is similar in nature to the fact flow 436 for the DailyRevenue process 400 discussed with respect to FIG. 4. However, there are two differences in this example. First, the two temporary files 522 are merged to match the redemptions to the corresponding offers by an outer join task 524 prior to further analysis. Second, a Boolean variable termed fresher can be created, as indicated at block 526, to indicate if the freshness interval for the flow should be changed. For example, if the number of redemptions for the campaign 500 exceeds a threshold, as indicated at block 528, the variable fresher can be set to “true” by a task 530. If fresher is true 532, a task 534 may divide the freshness interval into a smaller time interval, for example, in half. The QoX document 536 is updated with the new freshness interval.

Accordingly, the next iteration of the scheduler 502 will use the new freshness interval. Similarly, tasks may be included to lengthen the freshness interval in response to fewer redemptions than a threshold value.

This is not limited to single freshness interval changes. In an embodiment, a different extract flow in the Campaign process 500 may maintain running totals for each freshness interval. An additional flow, for example, an offer-generation flow, may be added to the Campaign process 500 and invoked by the Shopper process 510 to generate offers for shoppers in real time, based on the current statistics of a campaign, the customer segment, the region, etc. The extracted data for each offer in a partition of the marketing campaign 500 is provided to the load process 538, for example, by a message 540.

Since a textual or serialization format is generally used in order to process the conceptual model and generate an ETL logical model. In an embodiment, XML Process Definition Language (XPDL) can be used to provide an XML serialization for the BPMN models. XPDL is a format promulgated by the Workflow Management Coalition (WfMC) to interchange business process definitions between different workflow products, such as between different modeling tools and management suites. XPDL defines an XML schema that may be used for specifying the declarative part of workflow business process. Embodiments are not limited to XPDL as other systems, such as BPMN 2.0, may also be used to implement this functionality. Accordingly, the elements discussed below are merely provided as examples to clarify the explanation.

A number of XPDL elements may be used for the ETL conceptual model of the campaign 500 and BPMN constructs may be mapped onto the XPDL elements. In an embodiment, the XPDL constructs may be extended to add content for the conceptual model. Note that each XPDL object, which is an XML element, has an ID attribute that provides a unique identifier for the object and is used to reference the object from other elements. The elements that may be used In an embodiment are discussed further, below.

The top-level element in an XPDL document is Package/>. One package is used for each warehouse view, for example, dailyRevenue 400, as discussed with respect to FIG. 4, and campaign 500, as discussed with respect to FIG. 5. The package describes all messages, flows, and documents within it.

The element <Pools/> is used to describe each of the pools within a package. For example, the DailyRevenue process 400 has five pools, although one is collapsed. A BPMN pool may comprise a number of lanes where each lane represents a separate thread of activity within the pool. Thus, each pool element has an identifier and descriptors for the lanes within the pool. However, the pool element does not describe the actual flow within the pool, as discussed further with respect to WorkflowProcess.

The element <MessageFlows/> describes all message flows with the package. For example, DailyRevenue 400 has five message flows. Each message flow describes a single message and has attributes identifying the source and target of the message flow. This may be extended with an additional attribute identifying an XML schema for the message.

The element <Artifacts/> describes all artifacts in the package, one element per artifact. As mentioned previously, data object artifacts, such as documents are used to model the data flow. Thus, In an embodiment, each descriptor may be extended with an attribute for the document properties, such as its XML schema. It will be noted that associations between tasks and documents, such as the input or the output document, are not specified here, but are described further with respect to Associations.

The element <WorkflowProcesses/> describes the actual processes, including, for example, their steps and transitions. Each workflow process descriptor has two elements, <activities/> and <transitions/>. The activities element lists all steps in the process. The transitions element defines all sequence flows between steps, including, for example, the source and target of each transition. If a process contains sub-processes, these are encoded as activitySets which, like workflow processes, have an activities element followed by a transitions element. /

The element <Associations/> describes all associations between steps and documents in a package. Each element describes one association and identifies its source and target objects. For example, the QoX document in the scheduler pool 402 for the DailyRevenue process 400 has two associations, it is an output of the start step and, thus, is the target in that association. It is also the input to the loop sub-process, and, thus, is the source in that association.

The element <DataFields/> defines variables of the business process, such as decision data or reference data. Such variables may be referenced in expressions and conditions of tasks within the package. For example, the QoX objectives that are invariant for all flows within the business process could be defined here. In an embodiment, some QoX objectives may be specific to a flow and so are specified with the start step of that flow.

In an embodiment, tasks within a process flow can reference content within the data flow. For example, in the DailyRevFact flow 436 (FIG. 4), the parallel sub-process references each lineitem 460 in lineItemPart 452, the branch condition checks 438 if shipAddr is null, and so on. Thus, a naming convention may be used to resolve data references in the appropriate document and element with that document. Each document and message can have a unique name, such as QoX, order, and the like, and an XML schema describing its content. A data reference then names the relevant document or message along with an Xpath expression to reference its content. For example, the reference for the freshness or time interval parameter in the QoX document may be shown as QoK'freshness.

In addition to the elements and data flows discussed above, XPDL includes attributes for specifying the placement of model elements in a graphical representation. These can be used to derive placement attributes displaying the logical ETL model.

As mentioned above, an ETL design can be represented as a directed acyclic graph (DAG) in which the graph, G, is represented as a set of vertices (V) and edges (E), i.e., G=(V, E). The vertices (V) of the ETL graph are data stores and activities, in other words, operations and transformations, respectively. The ETL graph represents the flow of data from the source data stores, for example, operational systems, to the target data stores, such as the data warehouse and data marts, among others. As used herein, data marts are analytical data stores that can focus on specific business functions for a specific set of data consumers within an organization. The data flow is captured by the edges (E) of the graph, which are termed “provider relationships.” A provider relationship connects a data store to an activity or an activity to either another activity or a data store. In an embodiment, these constructs can be used to model data flow semantics and functionality.

In an embodiment, the ETL graph can be extended to incorporate additional design information like business requirements. Q. as QoX metrics and values, physical resources needed for the ETL execution Rₚ, and other generic characteristics, such as F, which may be useful for visualization. For example, such characteristics may include various rules, such as “the display of the flow should not span more than six inches before breaking a line,” “no more than three overlapping lines,” “use specific colors for specific types of operators,” and the like. In these embodiments, a parameterized version G(P) of the ETL graph can be used, in which the parameter seta P, is a finite set of properties that keep track of the above information.

Thus, an ETL design may formally be represented as a parameterized DAG G(P)=(V(P),E), where P=Qₓ ∪ Rₚ ∪ F. If additional design information is not needed, then P can be the empty set. In addition. P may contain zero or more elements representing the design phase, For example, at the logical level, the ETL design may not contain information about the physical execution, such as database connections, memory, and processing requirements and, thus, Rₚ can be empty.

In an embodiment, additional design information such as the QoX metrics can be assigned at different abstraction levels, such as at a flow. For example, an instruction may read “the F flow should run every 15 min.” The QoX metrics may also be recorded after a certain operation, for example, using an instruction that may read “add a recovery point after the O operator.” While the parameterized DAG G(P) covers the former case, the latter case can be modeled through the parameterized vertices V(P). For example, for meeting a certain recoverability requirement, a recovery point may be added after a certain operator O. This can be modeled as O(Qₓ), Qₓ=(add_RP).

In an embodiment, the vertices of the parameterized DAG may contain zero or more elements of P, which may be used differently at different design levels. For example, for a specific operation at the logical level, a property named “operational semantics” may describe an abstract generic algorithm, such as a merge-sort. In contrast, at the physical level. It may hold the path/name/command for invoking the code that executes the operation

For example, to denote that an ETL graph G₁ should be run at a freshness interval of 15 min, have a mean time to recover (MTTR) equal to 2 min., use 2 GB of memory and 4 CPUs, and use a certain database, dbx, for temporary storage, the graph can be expressed as G₁(P)={{cycle=15 min, MTTR=2 min}, {memory=2 GB, CPUs={cp1, cp2,cp3,cp4}, tmpdb_sid=dbx}}.

In an embodiment, the design can be optimized for recoverability and the requirement for recoverability may be pushed down to the operator level. As a result, the MTTR requirement may be achieved if a recovery point is added after an expensive series of operators and in particular after an operator Oₖ. Accordingly, the graph can be expressed as G₁(P)={{cycle=15 min}, {memory=2 GB, CPUs={(cp1,cp2,cp3, cp4}, tmpdb_sid=dbx}} and the parameterized set of vertices as V₁(P)={ . . . , Oₖ{{add_RP}, { }, { }), . . . }. Finally, it is possible to group parts of an ETL flow in order to create ETL subflows. In other words, an ETL graph G(P) may comprise several subgraphs Gⁱ(Pⁱ), where P=∪_{∀i}Pⁱ.

Different design alternatives may be used for the logical modeling of ETL flows, which can be based either on ad hoc formalisms or on a standard design language, such as UML. In an embodiment, XML notation can be used for representing the logical ETL models. As used herein, a logical ETL model expressed in XML is termed xLM.

The xLM model uses two main entities, the design and node elements. The <design/> entity represents an ETL flow or graph, Thus. ETL subflows are denoted as nested <design/> elements. The <node/> entity represents a vertex of the ETL graph, either activity or recordset.

The <design/> element contains all the information needed for representing an ETL flow. Its main elements include, for example, <node/>, <edge/>, <properties/>, <resources/>, and <features/>, among others. As discussed below, each <node/> represent a vertex of the ETL graph. Each <edge/> element stands for a provider relationship connecting two vertices, such as activities or data stores, among others. An edge element may have a name, a starting vertex, and an ending vertex. Additional information may be included in the parameter list, such as if the element is enabled, or the partitioning type, for example, if it participates in a partitioned part of the flow.

The <properties/> elements provides properties for an ETL graph. The ETL graph properties involve a set of QoX metrics defined at the flow Such properties are defined as simple expressions of the form: <qmetric>θ<value> or f(<qmetric>)θ<value>. Qmetric is a quantitative metric that may represent non-functional requirements, such as QoX metrics, including MTTR, uptime, degree of parallelism, memory, and CPUs, among others. The term f can be any built-in or user defined function, such as an aggregate function like min, max, or avg, among others. The term θ can represent any of the usual comparison operators like <, ≦, =, ≧, >, ≠, and so on. A value belongs to a domain specified accordingly to the respective qmetric. Thus, the variety of value domains has a 1-1 mapping to the variety of qmetric domains. Example properties may include ‘cycle=15 min’, ‘MTTR=2 min’, ‘failure probability≦0.001’, ‘max(tolerable failures)=2’, or ‘execution_window=2 h’, among others.

The <resources/> element specifies the set of resources needed for ETL execution. Typical resources include memory, CPUs, disk storage, db-connections, paths for tmpflog storage, and so forth. For example, the resources may bespecified as memory=2 GB, CPUs={cp1,cp2,cp3,cp4}, tmpdb_sid=dbx.

The <features/> element is a generic element that includes metadata needed for the visualization of the ETL flow. Typical metadata are x- and y-coordinates of the design, for example, of the upper right corner of a graphical bounding box. Other features include colors for each node type, language of the labels, font size and type, and so on.

The <node/> entity represents a specific vertex of an ETL graph. It consists of elements that specify, customize, and define the operation of the vertex. Its main elements include, for example, <name/>, <type/>, <optype/>, <schemata/>, <resources/>, and <features>. The <name/> element represents the name of the vertex. The <type/> element represents whether the vertex is an activity or a data store.

The <optype/> element represents the operational type of a vertex and defines its operational semantics. An extensible library of ETL activities or operations may be used, as shown in Table 1. The operational type can be any of these if the node represents an activity. If the node is a data store, then the optype represents the nature of the data store, for example, file, relational table, xml document, and so on. As discussed herein, at the physical level, this element specifies the path/name/command for invoking the actual implementation code that executes this operation.

The <schemata/> element describes the schemata employed by the node. These are the <input/>, <output/>, and <parameter/> schemata. The cardinality of the first two is equal or greater than one. If the node is a data store, then it has only one schema, and one input schema, with cardinality equal to one. The input and output schemata stand for the schema of a processing tuple before and after, respectively, the application of the operation. The parameter schema specifies the parameters needed for the proper execution of the operation. For example, for a filter operation O_{f}, the input schema can be {id, age, salary}, the output schema is the same, and the parameter schema is {age>30, salary<$3000}.

The <propenies/> element of a vertex involve a set of QoX metrics defined at the operator level. Again, such properties are defined as simple expressions of the form: <qmetric>θ<value> or f(<qmetric>)θ<value>d

The <resources/> element specifies the set of resources needed for executing the operation. Typical resources include memory, CPUs, path, and size for temporary storage on the disk, same for logging, and so forth. For example, the resources may he specified as

<resources><tmpdir>java.io.tmpdir</tmpdir><fresources>.

The <features/> element comprises metadata needed for the visualization of the vertex. Typical metadata are the x- and y-coordinates of the node, its color, font, and so forth.

TABLE 1
Example ETL generic operations

| | | |
|---|---|---|
| Simple operations; | Check operations: | System operations: |
| filter group by | key violation | socket reader |
| join diff | null values | socket writer |
| union sort function | unique values | file reader |
| application | | file writer |
| | | stream lookup |
| DW operations: | Row operations: | Transfer |
| SK assignment | splitter/merger | operations: |
| SCD-1/2/3 | duplicator | (de-)compress |
| row (de-)normalize | | encrypt/decrypt |
| pivoting | | file transfer |
| Scripting operations: | | |
| execute SQL script | | |
| execute Java/C++ code | | |

### Example of ETL Logical Process for DailyRevenue

In an embodiment, a conceptual model, as discussed above, can be mapped to a logical model. For example, the logical model for the DailyRevenue process 400 (FIG. 4) may be as shown in Table 2. For simplicity of explanation, Table 2 shows only the data flow. It will be noted that the conceptual extract becomes a table read, or extract activity, and that the message from extract to the fact flow becomes a data flow, connecting this operation with the rest flow, Some properties from the conceptual model can be used to create a control flow. For example, the conceptual design discussed above runs the extraction process with a frequency determined by a timestarnp range of [curTime—freshness, curTime]. This information may be used to schedule the task at the control flow, for example, by the scheduler 402.

TABLE 2
DailyRevenue ETL Logical Model.

<design>
<nodes>

<node>

<name>Lineitem</name>
<type>datastore</type>
<optype>TableInput</optype>
</node>

<node>

<name>Extract</name>
<type>activity</type>
<optype>ExecSQL</optype>
</node>

<node>

<name>γ(date,prodNum)</name>
<type>activity</type>
<optype>GroupBy</optype>
</node>

<node>

<name>SK(prodNum)</name>
<type>activity</type>
<optype>SKassign</optype>
</node>

<node>

...
<node>
<name>Load</name>
<type>activity</type>
<optype>ExecSQL</optype>
</node>
<node>
<name>DailyRevenueFact</name>
<type>datastore</type>
<optype>TableOutput</optype>
</node>
</nodes>
<edges>
<edge>
<from>Lineitem</from>
<to>Extract</to>
</edge>

<edge>

<from>Extract</from>
<to>γ(date,prodNum)</to>
</edge>

<edge>

<from>γ(date,prodNum)</from>
<to>SK(prodNum)</to>
</edge>
...

<edge>

<from>Load</from>
<to>DailyRevenueFact</to>
</edge>
</edges>
...
</design>

### Multi-Layer Design

Implementation of the models presented above is performed by creating a series of lower level designs from a higher level representation. For example, a conceptual design can be created, from which a conceptual model can be created. A logical model can be created from the conceptual model, and may be optimized. Finally, a physical model can be created from the logical model. Since a higher level model may lack the details that a lower level model uses, in each step, a designer may intervene and complement the design with further information.

The translation from the conceptual to the logical models is based on a search for patterns and the use of a simple language. The search for patterns is a design technique applied on the conceptual design for identifying logical operations. There are several patterns that one may identify on a workflow. in addition to those, in the context of ETL, some patterns may be of interest, such as patterns representing filter and extract operations, or paralielization, among others. For example, in the DailyRevFact flow 436 (FIG. 4) there is an exclusive branch to check if the shipAddr is null 438, which terminates flow immediately. This is a common pattern that reflects a filter operation, i.e., removing rows from a dataflow. As another example, the dailyRevExtract flow 406 shows a message receive task. receiving message 422, followed by a splitter 424, which is further followed by an appendFile 426. This pattern reflects the extraction of data from a data source to a staging table where the splitter describes that source tables to be joined, for example, orders and lineItems. However, as mentioned earlier, the value of the QoX objective could require that staging tables not be used, for example, for higher freshness.

The use of a simple language is a declarative technique that exploits annotation information in the conceptual design. For example, the table lookup task in hrlyCmpnFact 512 (FIG. 5) may be implemented in one of several ways depending on the size of the lookup table, the resources available, or the performance requirements. Similar considerations apply for the outer join task 516.

In an embodiment, each conceptual design construct may be annotated with documents containing a name, a set of input, output, and parameter schemata, a set of QoX objectives, and a set of expressions. For such annotations, a simple language may be used. The schemata are captured as <schema_type><schema_card>[<attr₁>, . . . , <attrₖ>]. For example, in an operation that has two input schemata, if the second input schemata involves two attributes a1 and a2, this may be written as <schemata><schema type=in card=2<attributes><attr>a1</attr><attr>a2</attr></attributes></schema></schemata>.

The QoX objectives can be stored as a set of strings that contain elements of the form: f(<metric>)θ<value>. In this expression, f can be any built-in or user defined function defined over the QoX metrics. As noted above, θ may represent typical comparison operators, such as <, ≦, =, ≧,>, ≠. For example an objective for max(freshness)=12 can be written as follows:

<QoX-objectives>

<objective/>

...

<objective/>

</QoX-objectives>
<objective>
<function>max</function>
<metric>freshness</function>
<operator>=</operator>
<value>12</value>
</objective>

Expressions may be similarly stared. This set may include notes as narratives. The notes may not be automatically translated or used, but may be used by the designer who will manually take the appropriate actions.

As will be clear, an appropriate parser may transform information from one model to another. In an embodiment, this may entail translating a model from one XML file containing XPDL constructs to another XML file containing xLM constructs. As both XPDL and xLM can describe graphs, there is a natural correspondence between many elements. For example, XPDL activities map to xLM nodes. XPDL transitions become xLM edges. XPDL workflows become xLM designs. XPDL document artifacts that describe dataf low are converted to schemata for nodes. QoX objectives in the XPDL become properties either at the flow level or the node level. However, the translation from XPDL to xLM may not be purely mechanical. As mentioned previously, patterns in the XPDL can be converted to specific operators. QoX objectives may affect the choice of operator or flow sequence. Further, parameters for templated nodes, for example, those with alternative implementations, can be manually selected.

Generation of the logical ETL model creates an ETL graph comprising activities and data stores as vertices and provider relationships as edges, and a more detailed representation of the design in XML form. The ETL graph can be used for optimizing the design, while the detailed representation can be used to create a corresponding physical model.

The ETL models may be optimized at different levels. For example, logical ETL designs may be optimized solely for performance or for a combination of performance, freshness, recoverability, and reliability. Since an ETL flow is represented as a DAG, a set of transitions may be introduced to modify parts of the graph. The transitions may change the position of operations or add new nodes, such as recovery points, splitting and merging operations, among others. Then, if the ETL graph is considered as a state, new states may be created using the transitions. Accordingly, the ETL optimization may be formulated as a state space problem. Thus, algorithms may be developed to efficiently navigate through the state spaces in order to identify near optimal states that satisfy given quality objectives. The input and output for this process are ETL graphs. In an embodiment, an XML representation represents ETL graphs in a convenient format, since most ETL tools use the same format for storing and loading ETL designs.

Once the logical model is processed, for example, completed with the appropriate details, and optimized, a corresponding physical design may be created. The details of the physical design are tied to the software used to implement the specific extract-transform-load functions, i.e., the ETL engine. Any number of different ETL engines may be used In an embodiment. The task of moving from the logical to the physical level may then be performed automatically by a parser that transforms the logical XML representation to the XML representation that the chosen ETL engine uses. Embodiments are not limited to any specific representation, including XML, and the logical XML file can be transformed to other proprietary formats. However, for simplicity of explanation, it may be assumed in this example that the ETL engine uses XML for importing and exporting ETL designs.

For example, the logical XML representation can be mapped to the XML format used by Kettle, which is an open source system available from Pentaho. This system may also be termed Pentaho Data Integration or PDI. Similarly, the XML representation can be mapped to other solutions like PowerCenter, available from Informatica, among others.

In Kettle, a prefix k:: is used to denote Kettle notation. Accordingly, a ‘k:transformation’ and a ‘k::job’ can be defined. The k::transformation is an. ETL data flows comprising a set of operations, The k::job is an ETL control flow that may have control operations, ETL operations, andk::transformations. In the generic case, the <design/> element of a model can be mapped to a k::job, and, if it contains nested <design/> elements, then these may be mapped to k::transformations. A summary of an XML schema for a k::transformation is shown in Table 3, although, for simplicity, only a subset of the supported elements is depicted.

TABLE 3
Example Kettle k::transformation.

transformation>

<info>
<connection>
</connection>

...

</info>
<order>

<hop>

```
  <from/>
  <to/>
  <enabled/>
```

</hop>

</order>
<step>

<name/>

<type

SortRows/>

<distribute/>
<copies/>
<partitioning>

<method/>

<schema_name/>

</partitioning>
<directory/>

<free_memory/>

<sort_size/>
<compress/>

<unique_rows/>

<fields>

<field>

<name/>

<ascending/>

</field>

</fields>
<GUI>

<xloc/>
<yloc/>

</GUI>

</step>

</transformation>

As shown in Table 3, the k::transformation may have three parts. The first part, bracketed by the <info> tags, contains generic information, such as the db connection, and the like. This information is populated using information from the resources Rₚ of the ETL (sub)graph G(P) mapped to this k::transformation. The second part, bracketed by the <order> tags, involves the provider relationships (edges of G(P)) that connect the vertices of G(P). Each edge of G(P) is mapped to a <hop/>. The execution order of ETL activities, i.e., the order of hops, does not necessarily correspond to the order of <hop/> in the <order/> listing, but is determined indirectly from the source <from/> and target <to/> of each <hop/>. Thus, for example, one can easily swap two ETL activities by simply correcting the respective <hop/>'s.

The third part involves the ETL activities. Each ETL activity is bracketed by <step> tags. A <step/> contains ail metadata needed for the execution of an ETL activity including, for example, name, type, partitioning method, physical resources (free memory, temp directory, sort size, compression, and the like), parameters needed (i.e., <fields/>), and visualization information (<GUI/>), among others. Depending on the type of each <step/> the metadata may change. In Table 3, the <type> of the <step> shown is SortRows, i.e., the described operation is a sorter.

The schema of the data can be defined in Kettle by defining a source data store. Then, depending on the functionality of each operation, the schema may change. However, the schema can be derived from the metadata, for example, if an operation does not change the schema, its output is similar to its input. The path may then be followed back to the data store if the original schema is known. Conversely, if the operation changes the schema, the metadata of the transformation may indicate how it changed.

Thus, for a certain vertex of G(P), v(P), the name and optype are mapped to <name/> and <type/> of a step. The input schemata can be used for the definition of the source data stores. If a schema is to be modified and provided that the type of <step/> allows for modification, then the schema of <step/> can be updated according to the formulae: generated attributes=output schema—input schema, and projected out attributes=input schema—output schema. The parameter schema of v(P) populates <fields/>. The physical resources Rₚ of v(P) are used to populate accordingly the physical resources of <step/>. Similarly, the properties Qₓ that made it to the physical level are mapped to the respective fields. For example, a requirement about partitioning populates the respective element by filling the <method/> and also defining other related parameters as <copies/> (e.g., degree of parallelism), <distribute/>, and so on. A requirement about increased freshness would affect the implementation type, such as by forcing a choice of an algorithm that can handle streaming data instead of using an algorithm which performs better (and possible more accurately) when it processes data in batch mode.

Finally, some features (either of G(P) or of a v(P)) are different in each design level. For example visualization information (e.g., x- and y-coordinates) is different in logical and physical designs, since the designs may contain different nodes and have different structure. However, the coordinates that Kettle uses from the logical XML representation may be calculated. For example, starting from the leftmost nodes of a logical design, an appropriate offset can be added to the logical horizontal coordinate based on the graphical element Kettle uses for the next operation. This can continue until the rightmost constructs are reached. The vertical positioning may also be mapped. In an embodiment, Kettle may simply annotate an operation run in ‘n’ branches with a tag denoting ‘n’ without further changing the graphical design.

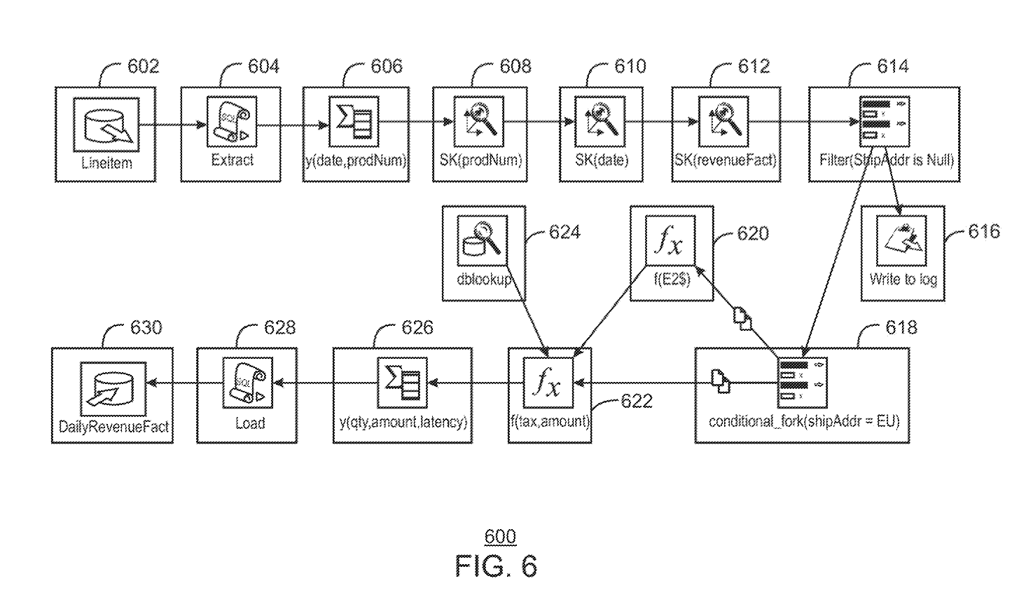

FIG. 6 is a block diagram of an ETL Physical Model 600 for the DailyRevenue process 400, in accordance with an embodiment. This example is implemented in the Kettle system described above. The model 600 begins at block 502 by obtaining a set of lineitems from an ordering database. At block 604, the set of order lineitems is extracted from the source database. Blocks 602 and 604 may encompass similar activities to those discussed with respect to the dailyRevExtract pool 406.

Blocks 606 through 626 may correspond to the dailyRevFact pool 436 of the dailyRevenue process 400. At block 506, the extracted set of line items is partitioned by date and product number. At block 508 the product key is determined from the product number. At block 510, the date key is determined for the line item from the date. At block 512, the revenue key is determined from the revenue fact. At block 514, a determination is made as to whether the shipping address is null. If so, process flow ends at block 516 with the writing of the record to a log file. If not, process flow proceeds to block 518, at which a determination is made as to whether the shipping address is in the European Union (EU). If so, process flow proceeds to block 520, where the tax amounts are set appropriately for the EU prior to process flow moving to block 522. If not, process flow proceeds directly to block 522, where the appropriate tax amount is calculated. If shipping is not to the EU, then the tax amounts are pulled from a lookup table, as indicated by block 524. At block 526, the line item information is aggregated with other items for the data and product. At block 528, the information is uploaded into a SQL database, such as a data warehouse. The process ends at block 530 with the calculation of the dailyRevenueFact.

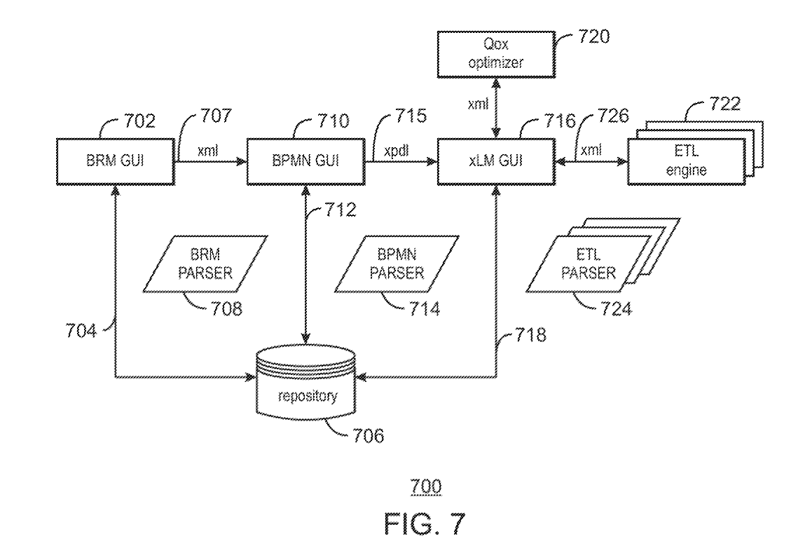

FIG. 7 is a block diagram of an ETL system 700, in accordance with an embodiment. This diagram may illustrate an operational or virtual structure for the ETL system, while the system 100 shown in FIG. 1 may illustrate a hardware environment for the ETL system. The ETL system 700 has a graphical user interface for generating a business requirements model (BRM GUI) 702. Error! Reference source not found. The BRM GUI 702 can be used, for example, by a business consultant, to capture business requirements and needs as service level agreements (SLAs) that can be expressed in terms of QoX metrics. As indicated by an arrow 704, the BRM generated may be stored in a Repository 706, such as an enterprise database.

Then, as indicated by arrow 707, a script-based BRM parser 708 can be used to transform the output of BRM GUI 702, into a conceptual model, for example, into a format readable by a graphical user interface for business process modeling notation (BPMN GUI) 710. In an embodiment, the output may be transformed manually by an ETL designer. After the BRM parser 708 is used to create the conceptual model, an ETL designer may complement the conceptual model with additional details, if desired. The conceptual model may be stored in the repository 706, as indicated by an arrow 712. In an In an embodiment, the Oryx BPMN modeling tool may be used as the BPMN GUI, for example, to manipulate the conceptual model. This tool can provide a graphical interface for creating BPMN 1.2 models and saving them, in XPDL format, among others. In an embodiment, the export function of the modeling tool may be augmented to add additional attributes to the conceptual model before a logical model is created.

The conceptual model created by the BPMN GUI 710 can be translated into a logical model in xpdl format by a BPMN parser 714, as indicated by arrow 715. The logical model may be manipulated by an xLM GUI 716. The logical model may be saved to the repository 706, as indicated by another arrow 718.

The logical model may be an ETL graph that can be graphically depicted through the xLM GUI 716, for example, using a visualization tool such as the GraphVIZ tool, available from AT&T, among others. The ETL graph can be optimized using a QoX optimizer 720. In an embodiment, the QoX metrics that may be optimized may include performance, recoverability, reliability, and freshness.

After the logical model is optimized, based on the designer's choice of ETL, engine 722, an appropriate parser 724 may be used to be transformed to an XML format readable by that ETL engine 722, as indicated by an arrow 726. Various ETL engines 722 that may be used include the open-source Kettle, Informatica PowerCenter, and a script-based ETL tool, called Dial, which was developed by Hewlett Packard Corporation.

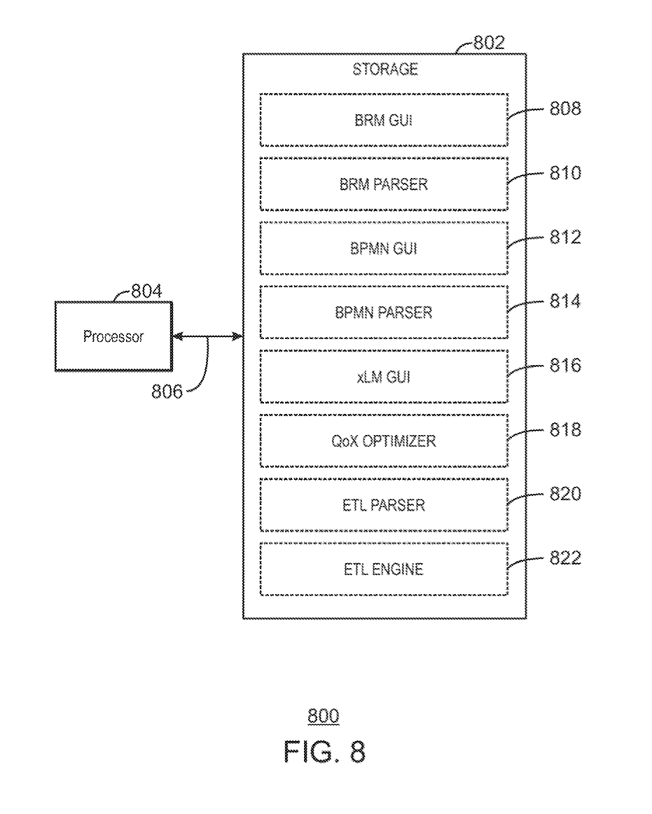

FIG. 8 is block diagram 800 of a non-transitory computer readable medium 802 containing data structures and code, in accordance with an embodiment. The non-transitory computer readable medium 802 may be accessed by a processor 804, for example, over a bus 808. The non-transitory computer readable medium 802 may include a memory, a hard disk, an optical disk, a flash disk, a RAM disk, or any combinations thereof.

The code may include modules that execute the functions described with respect to FIG. 7. For example, a BRM GUI 808 may allow graphical generation and manipulation of a business requirements model. A BRM parser 810 may convert the BRM into a business process modeling notation (BPMN) model that can be manipulated by a BPMN GUI 812. A BPMN parser 814 can convert the BPMN model into a conceptual model, for example, in xpdl, which can be manipulated by an xLM GUI 816. A QoX optimizer 818 may optimize the ETL process for various metrics. An ETL Parser 820 may generate a specific physical model that can be run by an ETL engine 822.

As described herein, embodiments provide a layered methodology for designing ETL processes for operational Business Intelligence. The methodology uses a unified formalism for modeling the operational processes of the enterprise as well as the processes for generating the end-to-end business views required for operational decision-making. The methodology starts with a business requirements specification phase in which the functional and non-functional requirements for the business views are captured. The ETL design then proceeds with the creation of a conceptual model, from which the logical definition and physical implementation are systematically derived. The conceptual model is based on BPMN and includes the definitions of the operational business processes, the data flow processes for generating the business views, and the mappings between them. Also included are the QoX objectives, which drive the design and optimization at the logical and physical levels. The logical model is XML-based and is rich enough to express the extraction, transformation, and load operators, used for the data flows that generate business views, but is not limited to any particular ETL tool. A physical model created from the conceptual tool is specific to an ETL tool, and, as described above, the Kettle ETL tool may be used.

What s claimed is:

1. A system for providing operational business intelligence, comprising:
a processor; and
a storage system, wherein the storage system comprises a plurality of functional data structures that may be accessed by the processor, wherein the plurality of functional data structures comprise:
a conceptual model comprising a view of a business process configured to realize a business view defined in a business requirements model (BRM);
a logical model created from the conceptual model; and
a physical model created from the logical model, wherein the physical model is linked to an extract-transform-load (ETL) engine, and wherein the ETL engine is configured to obtain data from an operational business process.

2. The computer system of claim 1, wherein the business view comprises data from the operational business process.

3. The computer system of claim 1, wherein he conceptual model is created from a business requirements model.

4. The computer system of claim 1, wherein the conceptual model is in business process modeling notation (BPMN).

5. The computer system of claim 1, wherein the conceptual model is configured to utilize quality objectives (QoX) stored in a QoX document to control an ETL process.

6. The computer system of claim 1, wherein the conceptual model is configured to receive a message from a probe in an operational business process linked to a local data source.

7. The computer system of claim 6, wherein the local data source is an order system, or warehouse database, or both.

8. The computer system of claim 6, wherein the operational business process operates comprises a delivery process, a shopping process, a checkout process, or any combinations thereof.

9. The computer system of claim 1, wherein the logical model is created by parsing the conceptual model into XML process definition language (XPDL).

10. The computer system of claim 1, wherein the storage system comprises code to direct the processor to manipulate a model, wherein the code comprises:
a business process modeling notation graphical user interface (BPMN GUI) to manipulate the conceptual model; and
an xLM graphical user interface (xLM GUI) to manipulate the logical model.

11. A method of providing operational business intelligence, comprising generating a multi-layer extract-transform-load (ETL) process by:
creating a conceptual model comprising a view of a business process configured to provide a business view defined in a business requirements model (BRM), wherein the conceptual model is a data structure configured to be utilized by a processor;
creating a logical model by parsing the conceptual model; and
creating a physical model by parsing the logical model.

12. The method of claim 11, comprising optimizing the logical model by fitting the logical model to a quality metric (QoX metrics).

13. The method of claim 12, wherein the QoX metric comprises performance, recoverability, reliability, freshness, maintainability, scalability, availability, flexibility, robustness, affordability, consistency, traceability, or auditability, or any combinations thereof.

14. A tangible, computer-readable medium, comprising code configured to direct a processor to:
create a conceptual model of a business process;
parse the conceptual model to create a logical model of the business process; and
parse the logical model to create a physical model of the business process.

15. The tangible, computer-readable medium of claim 14, comprising code configured to direct the processor to:
edit the conceptual model; and
edit the logical model.
